(19) United States
(12) Patent Application Publication
(10) Pub. No.: US 2016/0219804 A1
(43) Pub. Date: Aug. 4, 2016

(54) SYSTEMS, METHODS, AND DEVICES FOR WIRELESS IRRIGATION CONTROL

(71) Applicant: Skydrop Holdings, LLC, Highland, UT (US)

(72) Inventors: Matt Romney, Alpine, UT (US); Josh Heiner, Lehi, UT (US); Clark Endrizzi, Sandy, UT (US)

(73) Assignee: Skydrop Holdings, LLC, Highland, UT (US)

(21) Appl. No.: 14/989,756

(22) Filed: Jan. 6, 2016

Related U.S. Application Data
(60) Provisional application No. 62/100,449, filed on Jan. 6, 2015.

(51) Int. Cl. A01G 25/16; G05B 19/042

(52) U.S. Cl. CPC A01G 25/16; G05B 19/042; G05B 2219/2625

(57) ABSTRACT

The disclosure extends to apparatuses, methods, systems, and computer program products for optimizing water usage in irrigation. The disclosure also extends to apparatuses, methods, systems, and computer program implemented products for regulating the use of water over a computer network by generating irrigation protocols and sending those protocols wirelessly over the computer network. An irrigation controller includes a first radio, a control unit, and a second radio. The first radio is configured to wirelessly communicate with a wireless node to receive irrigation data for a location or an account corresponding to the irrigation controller. The control unit is configured to issue instructions to control flow of water through an irrigation system based on the irrigation data received via the first radio. The second radio is configured to communicate wirelessly with one or more remote irrigation adapters or sensors, wherein the second radio is configured for long range communication.

### RELATED APPLICATION

This application claims the benefit under 35 U.S.C. §119(e) of U.S. Provisional Application No. 62/100,449, filed Jan. 6, 2015 with a docket number SKY-0030.PO, which is hereby incorporated by reference herein in its entirety.

### TECHNICAL FIELD

The present disclosure relates wireless irrigation control and more particularly relates to wireless communication between a primary controller and one or more sensors or secondary controllers.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a perspective view of an embodiment of an irrigation controller that may be used within a system for executing irrigation protocols in accordance with the teachings and principles of the disclosure;

FIG. 2 is an overhead view of a landscaped yard divided into different irrigation zones and surrounding a house;

FIG. 3 is a schematic diagram of an optimized irrigation control system that communicates over network made in accordance with the teachings and principles of the disclosure;

FIG. 4 is a perspective view of an embodiment of an irrigation controller that includes a stacked control unit, an expansion module, and an irrigation adaptor made in accordance with the teachings and principles of the disclosure;

FIG. 5 is an exploded view of an embodiment of an irrigation controller that includes a stacked control unit, an expansion module, and an irrigation adaptor made in accordance with the teachings and principles of the disclosure;

FIG. 6 is a flow chart of an implementation of pairing between a user's control unit and an account, such as a web account, in accordance with the teachings and principles of the disclosure;

FIG. 7 is a flow chart of an embodiment of a method of initiating a smart irrigation system in accordance with the teachings and principles of the disclosure;

FIG. 8 is a flow chart of an embodiment of method for developing a protocol for a plurality of newly added irrigation components or expansion modules in succession at the startup of a system in accordance with the teachings and principles of the disclosure;

FIG. 9 is a flow chart of an embodiment of method for automatically detecting an expansion module in an irrigation system in accordance with the teachings and principles of the disclosure;

FIG. 10 is a schematic diagram of an embodiment of an irrigation system where a primary controller is wirelessly connected to one or more irrigation adaptors that may be remotely located in accordance with the teachings and principles of the disclosure;

FIG. 11 is a schematic diagram of hardware used in an embodiment of a primary controller made in accordance with the teachings and principles of the disclosure;

FIG. 12 is a schematic diagram of hardware used in an embodiment of a secondary controller made in accordance with the teachings and principles of the disclosure; and

FIG. 13 is a block diagram of an example computing device, such as a controller/control unit, made in accordance with the teachings and principles of the disclosure.

### DETAILED DESCRIPTION

The disclosure extends to apparatuses, methods, systems, and computer program products for optimizing water usage in growing plants for yard and crops. The disclosure also extends to apparatuses, methods, systems, and computer program implemented products for regulating the use of water over a computer network by generating irrigation protocols and sending those protocols wirelessly over the computer network. The disclosure discloses embodiments and implementations of improved control units for optimizing water use and additional environmental conditions. As used herein, the terms “environment” and “environmental conditions” are used to denote influence-able areas and conditions that can be adjusted by operable components of a system. For example, a landscape environment can be optimally irrigated or lit with operable components of corresponding systems such as sprinkler systems and lighting systems.

The disclosure also extends to methods, systems, and computer program products for smart watering systems utilizing up-to-date weather data, interpreting that weather data, and using that interpreted weather data to send irrigation protocols with computer implemented instructions to a controller. The controller may be electronically and directly connected to a plumbing system that may have at least one electronically actuated control valve for controlling the flow of water through the plumbing system, where the controller may be configured for sending actuation signals to the at least one control valve thereby controlling water flow through the plumbing system in an efficient and elegant manner to effectively conserve water while maintaining aesthetically pleasing or healthy landscapes.

In one embodiment, a primary irrigation controller may include a first radio to receive irrigation data, such as up-to-date weather data, as well as include a second radio to communicate wirelessly with one or more secondary irrigation controllers, sensors, lighting controllers, or the like. According to one embodiment, an irrigation controller includes a first radio configured to wirelessly communicate with a wireless node to receive irrigation data for a location or an account corresponding to the irrigation controller. The irrigation controller also includes a control unit that is configured to issue instructions to control flow of water through an irrigation system based on the irrigation data received via the first radio. The irrigation controller also includes a second radio configured to communicate wirelessly with one or more remote irrigation adapters or sensors, wherein the second radio is configured for longer range communication than the first radio.

A detailed description of systems and methods consistent with embodiments of the present disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for the purpose of clarity, certain technical material that is known in the related art has not been described in detail in order to avoid unnecessarily obscuring the disclosure.

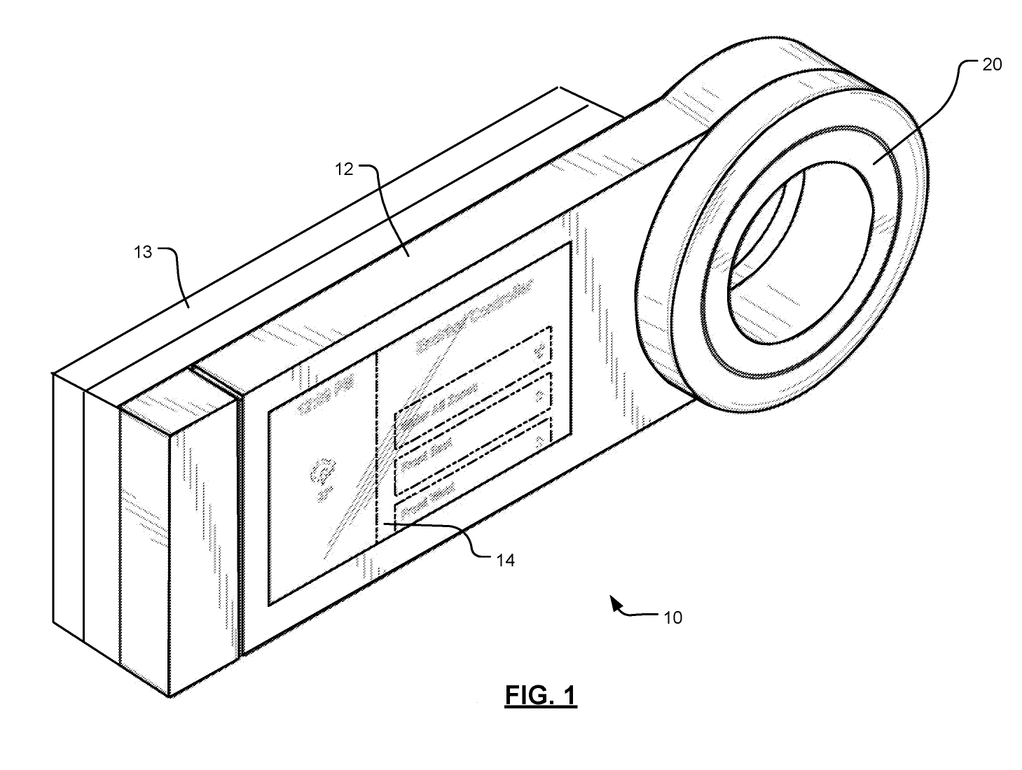

Turning to the figures, FIG. 1 illustrates an embodiment of an irrigation controller 10, also referred to sometimes as a control unit 10, that may be used within a system for executing irrigation protocols by causing operable irrigation components to actuate in accordance to the irrigation protocol. As can be seen in the figure, a control unit 10 may include a housing 12 and a user input 20 that provides an interface for a user to interact with the control unit 10. In an implementation the user input 20 may have a generally circular or annular form factor that is easily manipulated by a user to input data and to provide responses to queries. Other types of user interfaces may also be used including a physical keypad, a touchscreen, remote control using a smartphone or other device, or other type of human machine interface. The control unit 10 may further include an electronic visual display 14, either digital or analog, for visually outputting information to a user. As illustrated in the figure, an embodiment may include a stackable configuration, wherein the control unit 10 is configured to be stacked onto an irrigation adaptor 13 and/or other expansion modules, such that the electronic connector of the control unit mates with a corresponding electronic connector of the irrigation adaptor or other expansion modules to expand the capabilities or functionality of the control unit 10.

The housing 12 may be configured to be substantially weather resistant, such that it can be installed and used outdoors. The control unit 10 may be electronically, wirelessly, and/or directly connected to a plumbing system, such as an irrigation sprinkler system, that may have at least one electronically actuated control valve for controlling the flow of water through the plumbing system. Additionally, the controller 10 may be configured for sending actuation signals using wired or wireless communication to the at least one control valve, thereby controlling water flow through the plumbing system to effectively conserve water while maintaining aesthetically pleasing or healthy landscapes. In at least one implementation, the controller 10 may further include memory for recording irrigation iteration data (such as irrigation schedules for each zone or channel) for a plurality of iterations after a plurality of irrigation protocols have been executed. In an implementation, the controller 10 of a system and method may further record irrigation iteration data into memory in case communication with an irrigation server is interrupted.

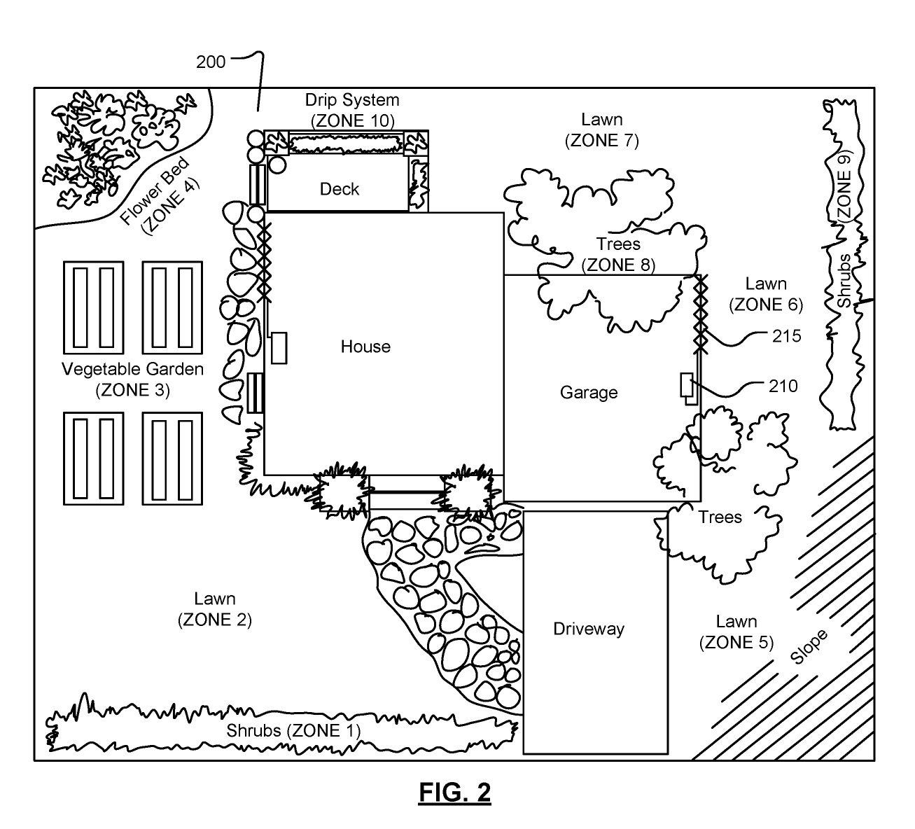

FIG. 2 illustrates an overhead view of a landscaped yard 200 surrounding a house. As can be seen in the figure, the yard 200 has been divided into a plurality of zones. For example, the figure is illustrated as having ten zones (Zones 1-10), but it will be appreciated that any number of zones may be implemented. The number of zones may be determined based on a number of factors, including soil type, plant type, slope type, square footage, area to be irrigated, etc., which may also affect the watering duration that is needed for each zone. In one embodiment, a controller 210 and its zonal capacity may determine the number of zones that may be irrigated. For example, a controller 210 may have a capacity of eight zones, meaning that the controller can optimize eight zones (i.e., Zone 1-Zone 8). However, it will be appreciated that any zonal capacity may be utilized.

In an implementation, each zone may have different watering needs. Each zone may be associated with a certain control valve 215 that allows water into the plumbing that services each area, which corresponds to each zone. As can be seen in the figure, a zone may be a lawn area, a garden area, a tree area, a flower bed area, a shrub area, another plant type area, or any combination of the above. It will be appreciated that zones may be designated using various factors. In an implementation, zones may be designated by the amount of shade an area gets. In an implementation, zones may be defined according to soil type, amount of slope present, plant or crop type and the like. In some implementations, one or more zones may include drip systems, or one or more sprinkler systems, thereby providing alternative methods of delivering water to a zone.

As illustrated in FIG. 2, some landscape may have a complex mix of zones or zone types, with each zone having separate watering needs. Many current watering systems employ a controller 210 for controlling the timing of the opening and closing of the valves 215 within the plumbing system, such that each zone may be watered separately. These controllers 210 or control systems usually run on low voltage platforms and control solenoid type valves that are either completely open or completely closed by the actuation from a control signal. Often control systems may have a timing device to aid in the water intervals and watering times. Controllers have remained relatively simple, but as disclosed herein below in more detail, more sophisticated controllers or systems will provide optimization of the amount of water used through networked connectivity and user interaction as initiated by the system.

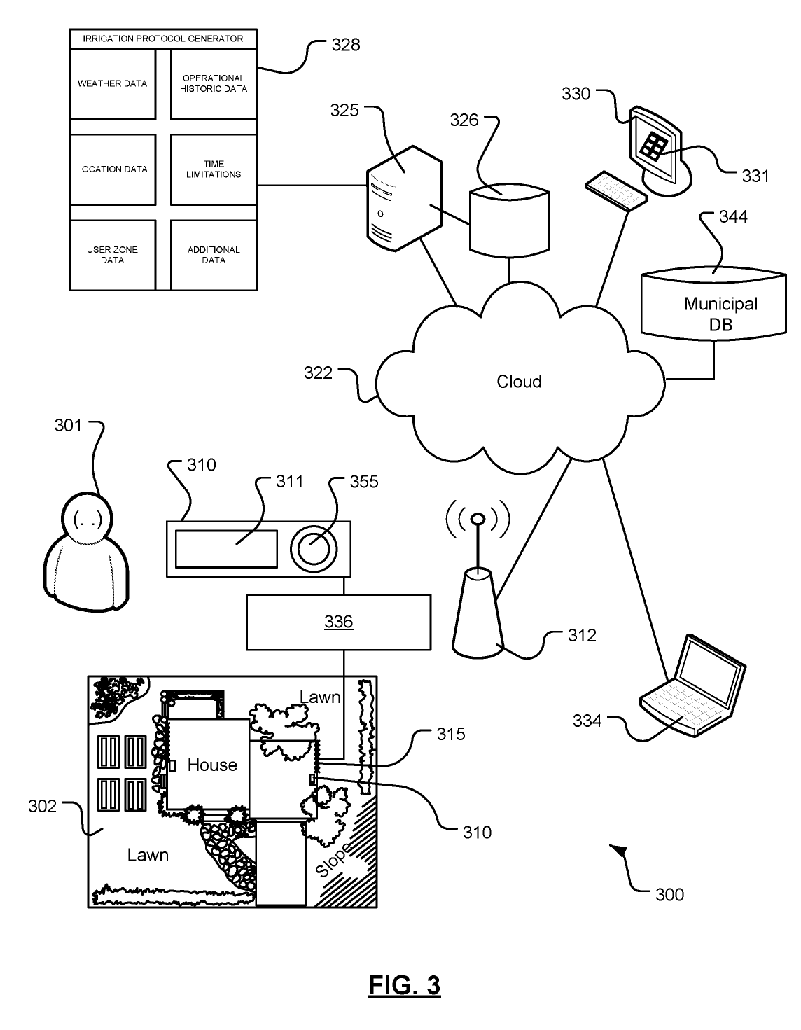

FIG. 3 illustrates a schematic diagram of an optimized irrigation control system 300 that communicates over network in order to benefit from user entered, crowd sourced, and other irrigation related data stored and accessed from a database 326. As illustrated in the figure, a system 300 for providing automated irrigation may include a plumbing system, such as a sprinkler system (all elements are not shown specifically, but the system is conceptualized in landscape 302), having at least one electronically actuated control valve 315. The system 300 may also include a controller 310 that is electronically connected to or in electronic communication with the control valve 315. The controller 310 may have a display 311 or control panel and an input 355 for providing information to and receiving information from the user. The controller 310 may include a display or a user interface 311 for allowing a user to enter commands that control the operation of the plumbing system. The system 300 may also include a network interface 312 that may be in electronic communication with the controller 310. The network interface 312 may provide network 322 access to the controller 310. The system 300 may further include an irrigation protocol server 325 providing a web based user interface 331 on a display or computer 330. The system 300 may include a database 326 that may include data such as weather data, location data, user data, operational historical data, and other data that may be used in optimizing an irrigation protocol from an irrigation protocol generator 328.

The system 300 may further include a rule/protocol generator 328 using data from a plurality of databases for generating an irrigation protocol, wherein the generation of an irrigation protocol is initiated in part in response to at least an input by a user. It should be noted that the network 322 mentioned above could be a cloud-computing network, and/or the Internet, and/or part of a closed/private network without departing from the scope of the disclosure.

In an implementation, access may be granted to third party service providers through worker terminals 334 that may connect to the system through the network 322. The service providers may be granted professional status on the system and may be shown more options through a user interface because of their knowledge and experience, for example, in landscaping, plumbing, and/or other experience. In an implementation, worker terminals may be a portable computing device such as portable computer, tablet, smart phone, PDA, and/or the like.

An additional feature of the system 300 may be to provide notices or notifications to users of changes that impact their irrigation protocol. For example, an implementation may provide notice to a home owner/user that its professional lawn service has made changes through a worker terminal 334. An implementation may provide a user the ability to ratify changes made by others or to reject any changes.

In an implementation, an irrigation system 300 may include a plurality of control valves 315, wherein each control valve corresponds to a zone of irrigation. In at least one implementation, the controller 310 may be a primary controller and may communicate over a wired or wireless connection with a secondary controller 336 which controls actuation of the control valves 315. For example, capabilities of the irrigation system 300 may be expanded by adding secondary controllers, which can control additional stations or valves or be positioned at different locations than a primary controller. Using a wireless communication technology between a primary controller and secondary controller may allow for easy expansion without wiring or providing trenches between controllers. Thus, large areas may be covered using a primary controller and one or more secondary controllers.

In an implementation, user communication may be facilitated through a mobile application on a mobile device configured for communicating with the irrigation protocol server 325. One or more notifications may be provided as push notifications to provide real time responsiveness from the users to the system 300.

The system 300 may further include an interval timer for controlling the timing of when the notifications are sent to users or customers, such that users/customers are contacted at useful intervals. For example, the system 300 may initiate contact with a user after predetermined interval of time has passed for the modifications to the irrigation protocol to take effect in the landscape, for example in plants, shrubs, grass, trees and other landscape. In an implementation, the notifications may ask the user to provide information or indicia regarding such things as: soil type of a zone, crop type of a zone, irrigation start time, time intervals during which irrigation is occurring, the condition of each zone, or other types of information or objective indicia.

In one embodiment, the server 325 may include information about a web account corresponding to the system 300. The web account may store information about the user, the landscape 302, or any other data about watering or irrigating for the user or properties owned by the user.

The user 301 may input data via a controller 310 or via the web account without departing from the scope of the disclosure. A pairing process between the controller 310 and the web account may aggregate user input data entered at the controller and through the web account. The system 300 may include a clock configured to provide time stamp data to events within the system 300. The system 300 may further include a notice generator that generates notifications for users 301 regarding events within the system 300 and transmits the notifications to users 301. The system 300 may include an irrigation protocol that itself may include instructions for the controller 310 derived in part from user responses to the notifications and time stamp data. In an implementation, the system 300 may communicate with a mobile application on a mobile device of the user 301 for communicating with the irrigation protocol server 325.

The type of user data that may be entered and shared with the system 300 may include the information provided herein, including without limitation soil type, crop or plant type, sprinkler type, slope type, shade type, irrigation start time, an irrigation interval of time in which irrigation may take place for one or more zones. In an implementation, the system 300 may further include a predetermined interval for initiating queries to users 301. In an implementation, the system 300 may be configured to perform a pairing process between the controller 310 and a web based network or service, such as a cloud service.

It will be appreciated that the optimization of the irrigation and plumbing system may be to provide the requisite water needed to maintain a healthy landscape and no more. Thus, the general understanding is that the amount of water that is lost during evapotranspiration per zone must be replenished at each irrigation start and run time. Evapotranspiration is the amount of water lost from the sum of transpiration and evaporation. The U.S. Geological Survey defines evapotranspiration as water lost to the atmosphere from the ground surface, evaporation from the capillary fringe of the groundwater table, and the transpiration of groundwater by plants whose roots tap the capillary fringe of the groundwater table. Evapotranspiration may be defined as loss of water from the soil both by evaporation from the soil surface and by transpiration from the leaves of the plants growing on it. It will be appreciated and understood that factors that affect the rate of evapotranspiration include the amount of solar radiation, atmospheric vapor pressure, temperature, wind, and soil moisture. Evapotranspiration accounts for most of the water lost from the soil during the growth of a plant or crop. Accurately estimating evapotranspiration rates is an advantageous factor in not only planning irrigation schemes, but also in formulating irrigation protocols to be executed by a controller to efficiently use water resources.

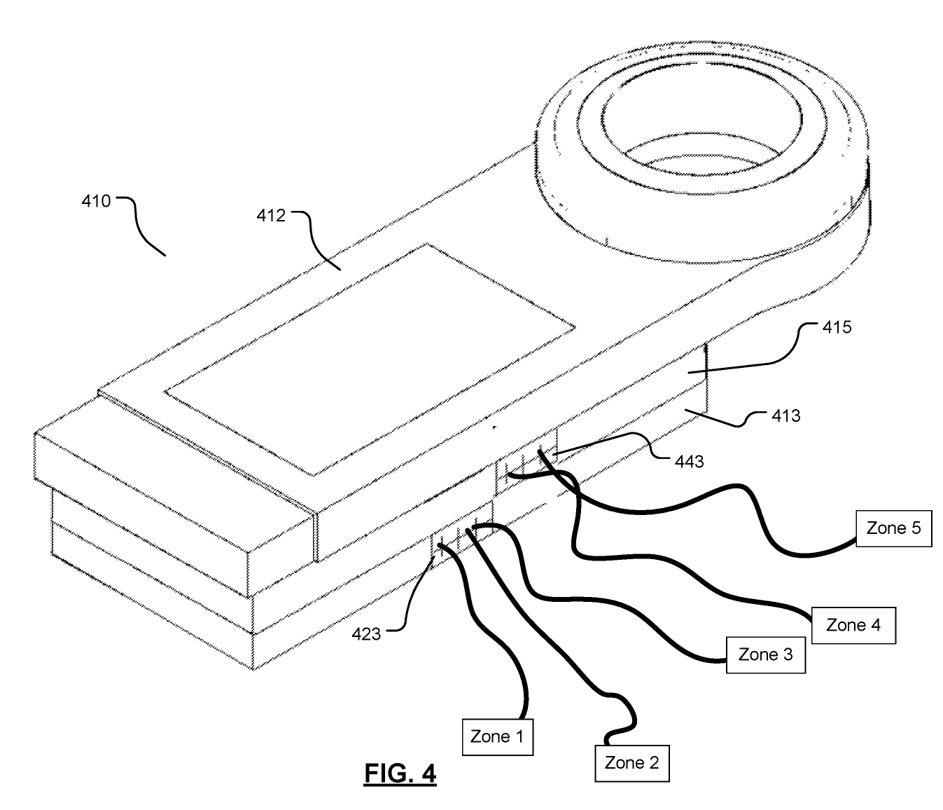

FIG. 4 illustrates an embodiment of an irrigation controller that includes a stacked control unit 412, expansion module 415, and irrigation adaptor 413. In an embodiment, an irrigation adaptor 413 may include wired or wireless communication interfaces for communication with other components such as, sprinklers, drippers, control units, and servers. For example, the irrigation adapter 413 may include a radio for communicating with one or more remotely located control units, sensors, or the like. For example, the remotely located control units may include radios to allow communication with the controller 410.

As can be seen in the figure, the expansion module 415 may provide the additional functionality of controlling more irrigation zones. For example, an irrigation adaptor 413 may control one or more zones, such as a plurality of irrigation zones. As a specific example illustrated in FIG. 4, the irrigation adaptor 413 may control irrigation zone 1, zone 2, and zone 3. In order to provide control over one or more additional zones, an expansion module 415 may be provided that is electronically connected to additional operable irrigation components that irrigate additional zones, which may not be controlled by the irrigation adaptor 413. In the example illustrated in FIG. 4, the expansion module 415 controls zone 4 and zone 5. As shown in the figure, wires connecting the irrigation components may physically pass through wire ports 423 and 443 disposed in a housing wall of the irrigation adaptor 413 and expansion module 415, respectively.

In one embodiment, the expansion module 415 may provide for wired or wireless connectivity of additional system components, such as various sensing abilities through the connection of flow sensors, temperature sensors, moister sensors, light sensors, wind sensors and the like. In at least one embodiment, the expansion module 415 may provide communication and control functionality such as wireless control of remotely placed irrigation components. For example, the expansion module 415 may include a radio that is configured to communicate using a different communication protocol frequency, or technology than the control unit 412. For example, the control unit 412 may communicate with a Wi-Fi node to provide cloud or internet access to the control unit 412 (for example to link the irrigation controller to a web account or receive irrigation data or weather data from another computer or from a server via the Wi-Fi network or the Internet).

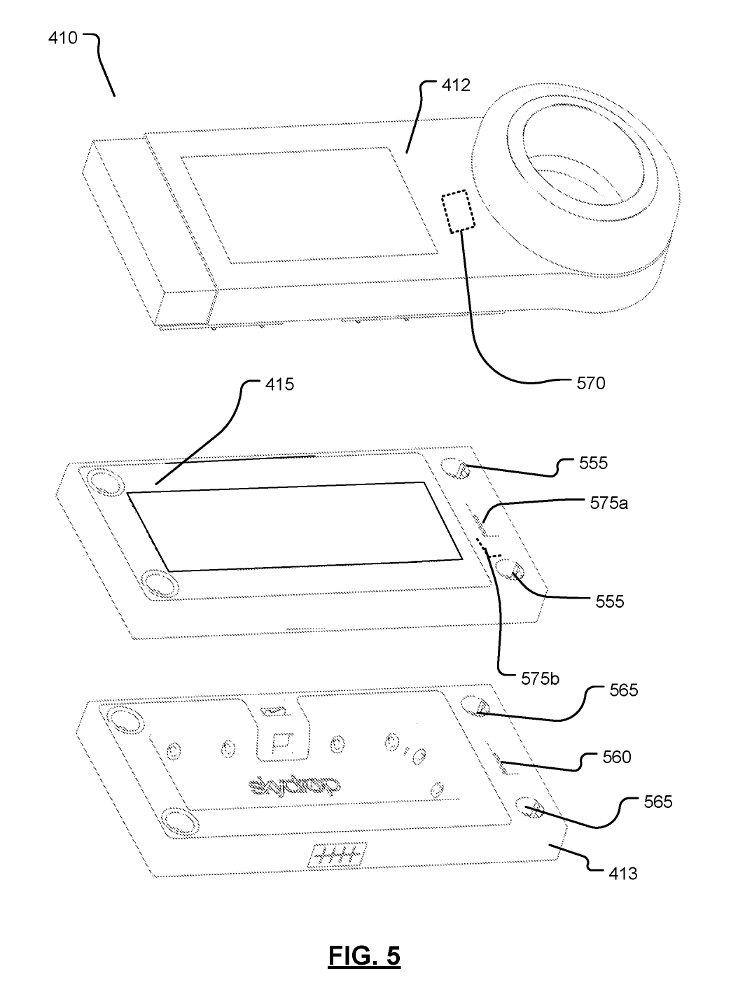

As can be seen in FIG. 5, an embodiment of the expansion module 415 may include attachment structures 555 that correspond to complimentary attachment structures on the control unit 412 and adaptor 413 to allow the expansion module 415, adapter 413, and control unit 412 to stack. The attachments may be configured with known or yet to be discovered attachment structures such as protrusions, male-female structures, and common fasteners. For example, the attachment structures may include male and female portions that interact and mate mechanically in a detachable manner allowing for expansion and maintenance of the system. Magnets may be used for physically connecting a control unit to an adaptor. Other examples could be all manner of fasteners such as screws, bolts, nails, and the like.

Additionally, in an embodiment the control unit 412 may be in electronic communication and mechanical communication with the irrigation adaptor 413 through an expansion module 415. As can be seen in the figure, the adaptor 413 may include one half of an electronic connector 560 and the control unit 412 may include a corresponding half of an electronic connector 570 (show schematically in phantom lines) that both electronically connect to corresponding electronic connector halves on opposing faces of the expansion module 415.

In a stacked embodiment, for example, the attachment structures 555, 565 may be configured so as to cause the alignment of the first and second halves of the electronic connectors. Connector combinations may include male and female connectors, biased-compression connectors, and friction connector configurations to provide secure electronic communications. For example, the control unit 412 may include a male electronic connector 570 (as shown in phantom lines) that corresponds with a female electronic connector 575 of the expansion module 415. Likewise, the control unit 412 may be mechanically connected to the expansion module 415 in order to complete an expanded controller.

FIGS. 4 and 5 illustrate an embodiment wherein an irrigation adaptor 413, expansion module 415, and control unit 412 are configured to be stacked, such that a backside of the control unit 412 mates with the front side of the expansion module 415 and a backside of the expansion module 415 mates with a front side of the irrigation adaptor 412. In an implementation, a backside of the adaptor 413 may be mounted to a substantially vertical surface, such as a wall, and wired to operable components of an irrigation system, such as solenoids.

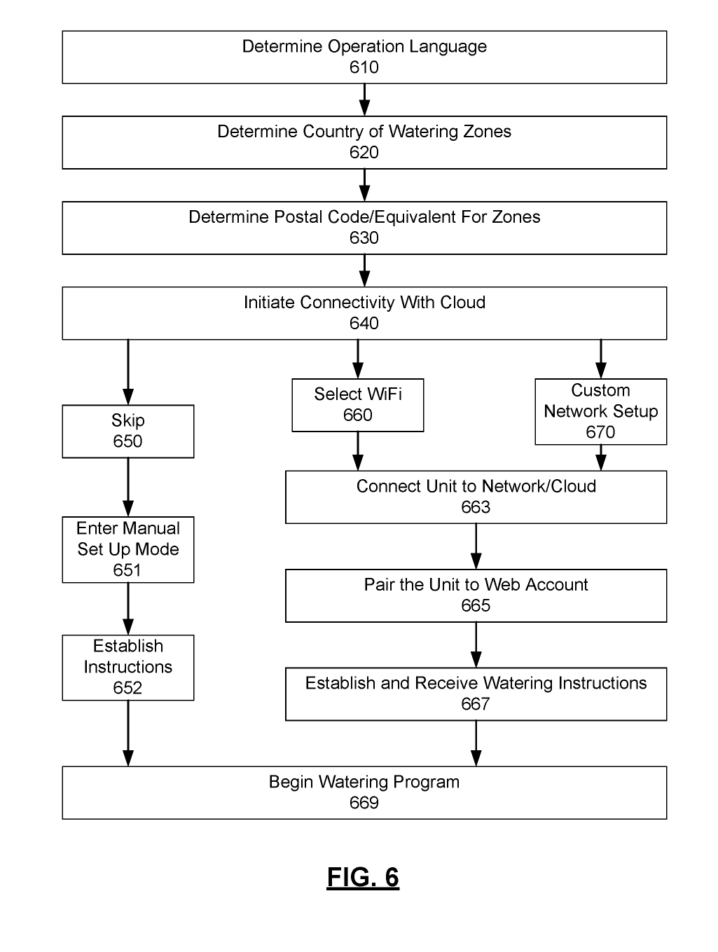

Referring now to FIG. 6, there is illustrated an implementation of pairing between a user's control unit and an account, such as a web account. FIG. 6 illustrates, a method for initiation of an irrigation optimization system having the features of the disclosure. The method may initiate at 610 by determining the language the user will use in interacting with the system. The user selection will be recorded into computer memory on the system. At 620, the geographical location of the user may then be determined, and at 630 the geographical location may be further refined more specific questions. Once the location has been established, the system may then establish connectivity with a cloud network at 640.

At 650, the network connectivity may be skipped and at 651 a user may be asked to manually set up a watering protocol by responding to questions from the control panel. At 652, a watering protocol of instructions will be generated and, at 669, irrigation may begin automatically.

Alternatively, at 660, a user may be presented with available Wi-Fi connection options and may choose the desired connection, or at 670 a user may enter custom network settings. Once connected to the network cloud at 663, the control panel may be paired with an online account previously (or concurrently) set up through a web interface at 665.

At 667, a watering protocol may be generated and transmitted through the cloud to the paired controller, wherein the watering instruction are formulated from user responses to quires output from the system through the web account or through the control panel user interface. At 669, the system may begin the watering protocol that has been received from the cloud network.

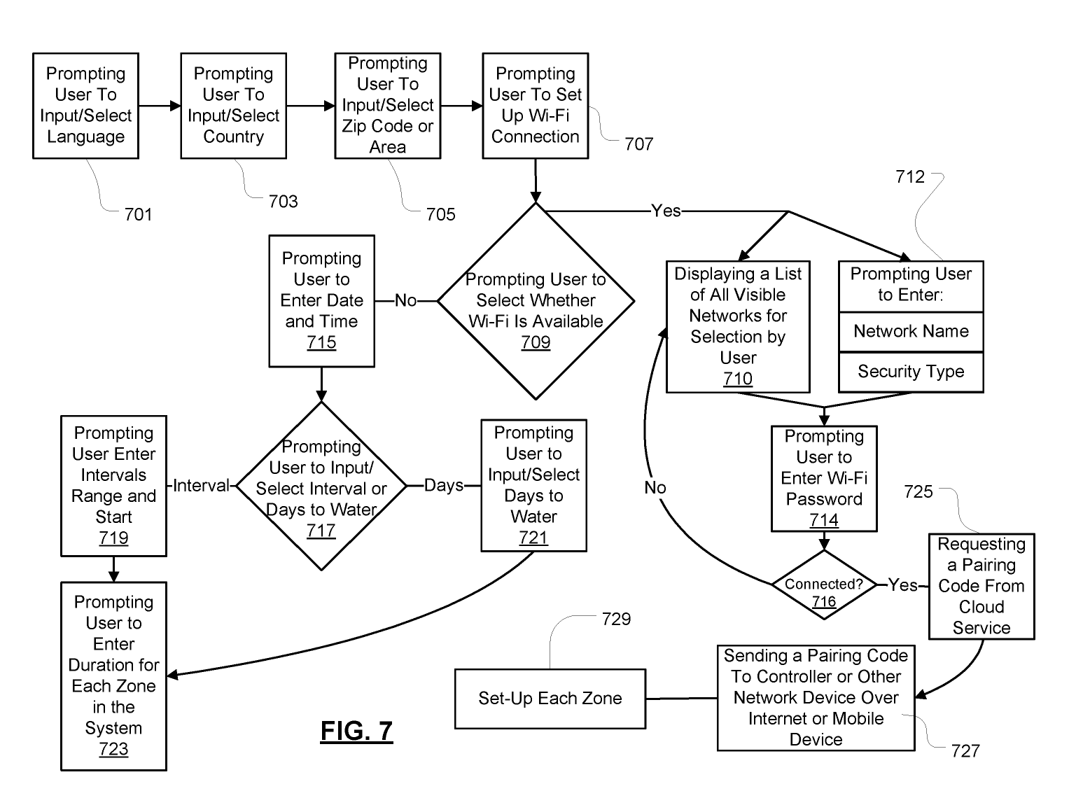

FIG. 7 illustrates a method of initiating a smart irrigation system comprising specific logic when initializing a new control panel. After a control panel has been wired to a plurality of control valves, the user/customer may be lead through a series of queries by a control panel interface. In order to initialize the interface and language of communication may be selected at 701. Next at 703 the user may be prompted to select the country in which they and the property to be watered resides, and the user may be prompted for further refinement of location at 705.

At 707, the user may be prompted to set up a connection to a cloud network through a Wi-Fi internet connection. At 709, the user may be prompted to choose whether or not connect to the cloud or run the irrigation system manually from the control panel.

If the user decides not to connect to the internet, at 715 the user may be prompted to enter data in manually, such as data and time. At 717, the user may be prompted to manually select or enter an irrigation interval or days to water. If the user chooses to enter an interval, at 719 the user will be prompted to enter the interval. Alternatively, if the user selects to irrigate according to days, at 721 the user will be prompted to enter the days for irrigation. It should be noted that in an implementation the user may be able to select both irrigation days and irrigation intervals. At 723, the user will be prompted to enter a duration and/or day for each of the zones controlled by the control panel.

At 709, if the user had chosen to connect to a network then the user would be prompted to select from available networks at 710, or enter security information for a custom network at 712. At 714, the user may be prompted for a password. At 716 if the password fails the user will be redirected to 710 or 712 to retry the network security information. At 716, if connecting to the internet is successful, at 725 a pairing request will be sent to the control panel that will pair a cloud base web account to the control panel. Additionally, at 727 pairing codes may be established for a plurality of computing devices comprising: additional controllers, mobile devices, computers, etc. At 729, each zone is set-up using the controller.

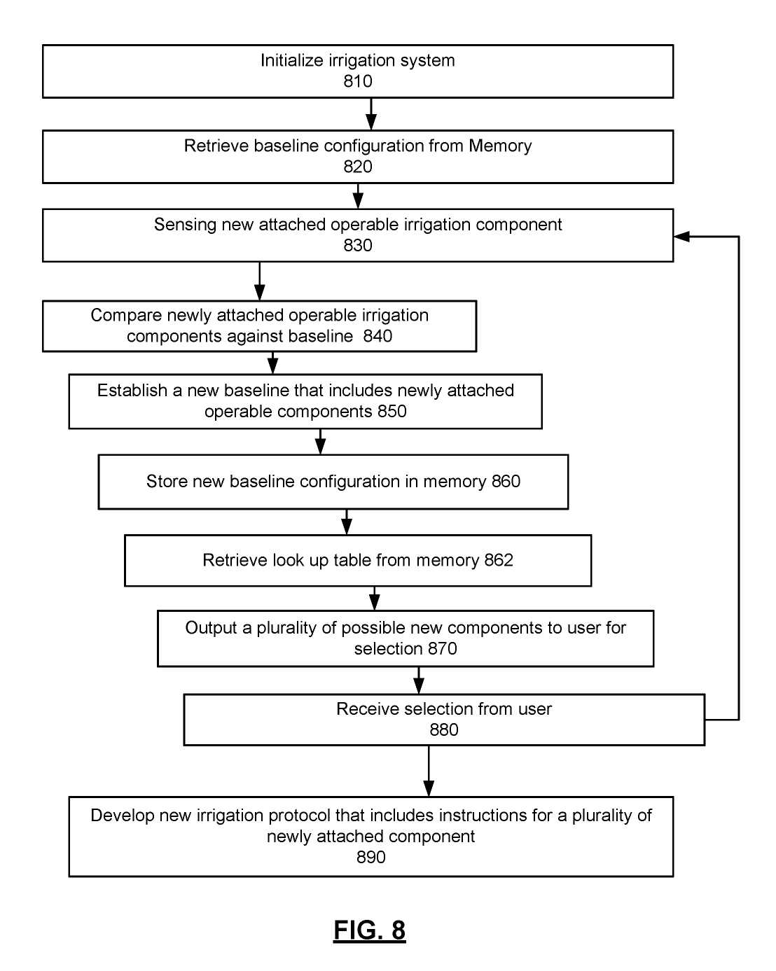

Illustrated in FIG. 8 is a method for developing a protocol for a plurality of newly added irrigation components or expansion modules (such as the irrigation component 413 or expansion module 415 of FIG. 4) in succession at the startup of a system. The method may be used for newly added components that communicate in a wired or wireless manner to a control unit, irrigation adapter, and/or expansion module. As illustrated in the figure, a method for the detection of added operable irrigation components at system startup may include a process of powering on an irrigation system having added operable irrigation components that are in electronic communication with an irrigation controller at 810. In an implementation, the irrigation controller may be configured for use as a component of a computer network, wherein the irrigation controller may comprise a control unit and an irrigation adaptor. The adaptor may be configured to actuate operable irrigation components that operate according to instructions issued from the control unit. Additionally, the method may include retrieving a baseline configuration from computer memory at 820. The baseline configuration may include the components that have previously been installed within a system.

At 830, the method may further include sensing a new attached operable irrigation component (such as an irrigation adapter, irrigation sensor, or expansion module). The sensing process may include receiving self-identifying information from the newly installed components or may be derived by sensing various electrical characteristics of the system, such as current draw, resistance, inductance, impedance, etc., as electrical current flows through the system.

If a plurality of new components have been attached or installed to the system, the following may be repeated in sequence until all the newly added components are accounted for as is illustrated in the figure. At 840, the method may further include the process of comparing the new sensed irrigation component or components to a baseline configuration comprising any previously attached components in order to discover the new component or components.

At 850, the method may further include establishing a new baseline configuration that includes the newly attached irrigation component and then storing at 860 the new configuration in memory for later use when adding new components or for performing future iterations as additional operable components are discovered.

At 862, the method may further include retrieving a lookup table from memory that includes data relating to possible operable irrigating components. The lookup table may be periodically downloaded over a network so as to contain updated information. The lookup table may include identifying information for components such as identifiers and electrical properties such as current draw, resistance, impedance, etc.

In an implementation, sensing the current draw may include comparing the value of the current draw to an operational threshold/window comparator. If the value of the current draw falls within a predetermined threshold or window then there is an operable component attached to the system and is useable by the system. At that point, the system may go through a setup process described herein above. For example, it will be appreciated that when a current voltage is sent across a sense resistor the result is compared to two other preset voltages that define the thresholds/window of operation. If the value of the current voltage falls outside of the thresholds/window then there is either no new operable component or there is a faulty operable component attached to the system.

At 870, a plurality of possible new operable irrigation components may be identified as a group that may be output to a user so that the user may select the exact component from the list. At 880, the selection may be received from a user and stored in memory.

At 890, a protocol may be generated that includes instructions for the new operable component or components.

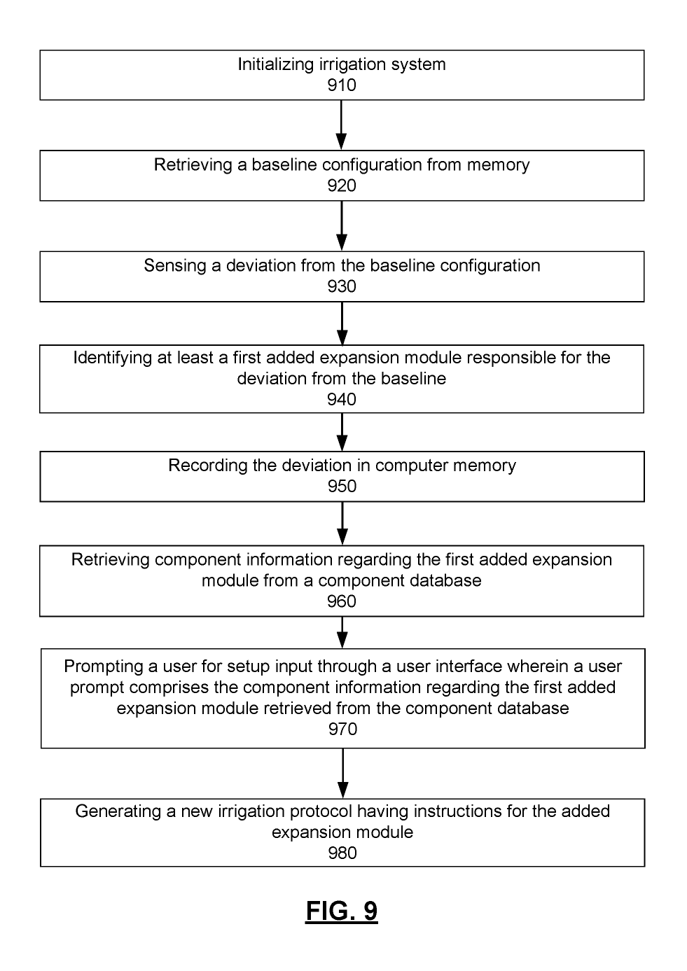

FIG. 9 illustrates an implementation of a method for automatically detecting an expansion module in an irrigation system. The method for the detection of the expansion module in an irrigation system illustrated may include powering on or initializing an irrigation system at 910. The irrigation system may have one or more operable irrigation components. The operable irrigation components may include a sensor, where the operable irrigation components are in electronic communication with an irrigation controller. The irrigation controller may be configured for use as a component of a computer network, wherein the irrigation controller receives an operating protocol or an irrigation protocol from the irrigation server over the computer network. The irrigation controller may include a control unit and an irrigation adaptor. The adaptor may be configured to actuate operable irrigation components that operate according to instructions issued from the control unit. It will be understood that the adaptor may be configured to actuate the operable irrigation components that operate according to instructions issued from the control unit.

The irrigation controller may also include an expansion module. The expansion module may be used to expand or add to the functionality of the irrigation controller. The expansion module may be added to the system at any time, whether upon initial setup of the irrigation controller or at a later time when a need arises for additional zones, sensors or the like to be added to the system. The expansion module may be configured to be disposed in a stacked configuration.

Continuing to refer to FIG. 9, the method may include retrieving a baseline configuration from computer memory at 920. At 930, the method may further include sensing a deviation from the baseline configuration. The deviation may be generated by the added expansion module. At 940, the method may include identifying at least a first added expansion module that is responsible for the deviation from the baseline. The deviation may be recorded into computer memory at 950. At 960, the method may include retrieving component information regarding the first added expansion module from a component database. At 970, the method may include prompting a user for setup input through a user interface. It will be appreciated that a user prompt may include the component information regarding the first added expansion module retrieved from the component database. At 980, the method may include generating a new irrigation protocol having instructions for the added expansion module.

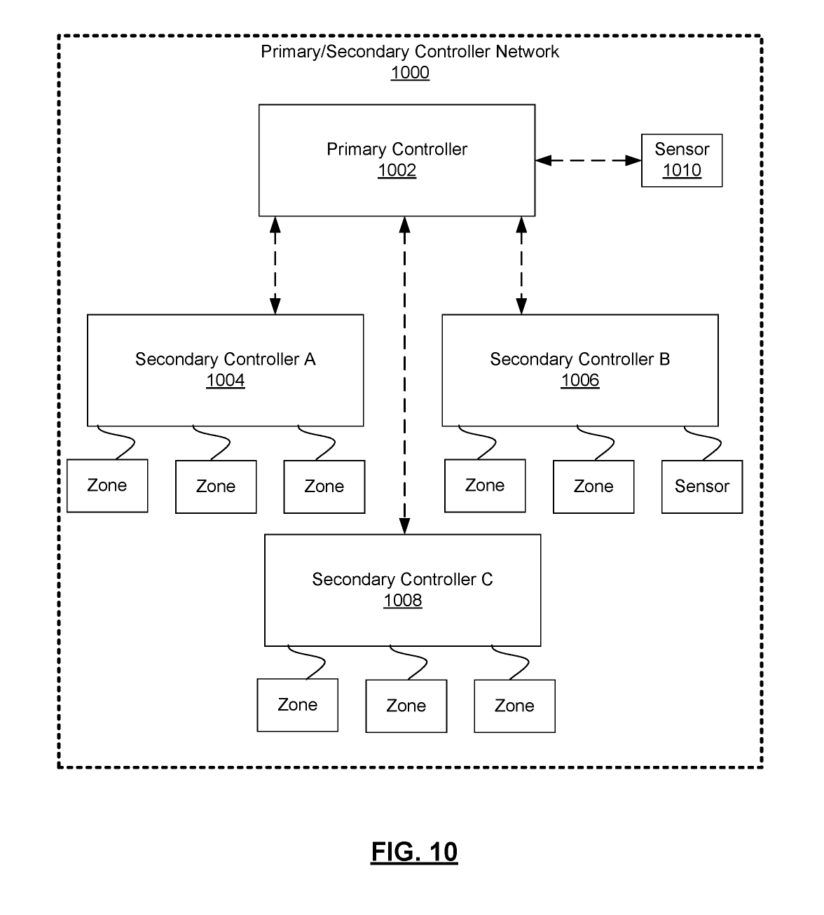

FIG. 10 illustrates an embodiment of an irrigation system where a primary controller 1002 in the control unit is wirelessly connected to one or more irrigation adaptors that may be remotely located. In one embodiment, a control unit may include a primary controller 1002 that wirelessly communicates with one or more secondary controllers 1004, 1006, 1008 that control irrigation valves, lighting, or the like covering a plurality of zones. In the figure, dashed lines are used to represent wireless communication and/or a wireless network. For example, the primary controller 1002, a secondary controller A 1004, a secondary controller B 1006, a secondary controller C 1008, and a sensor 1010 may form a primary/secondary controller network 1000. Based on the wireless communication between the primary controller 1002, the sensor 110, and the secondary controllers 1004, 1006, and 1008, a control unit can wireless control a large number of zones spread over a large distance. For example, the primary controller 1002 may be located within a building or garage, while a secondary controller or sensor can be located outside, in a different building or room, or buried underground at a distance from the primary controller 1002. Because the devices communicate wirelessly, no wiring, trenches, or the like is required between the primary controller 1002, the sensor 1010, and the secondary controllers 1004, 1006, and 1008.

In an implementation, wireless communication may be facilitated with the use of long range communication radios. For example, the radios of the primary controller 1002, secondary controllers 1004-1008, and/or sensor 1010 may operate at a frequency and/or power level to allow signals or messages to be sent or received at distances of hundreds of meters, one or more miles, or greater in conditions with low amounts of obstacles or barriers. As another example, the frequency and/or power level may be sufficient to travel several feet through soil, structural walls, and/or concrete. One of skill in the art will recognize that the distance over which radios can communicate varies widely based on structures, hills, trees, soil type, and/or the like.

In one embodiment, the radios may use an industrial scientific medial (ISM) radio band for communication. In one embodiment, the primary controller 1002, secondary controllers 1004-1008, and/or sensor 1010 may communicate using a frequency in the 800-1000 MHz range or 400-500 MHz range. According to one embodiment, the radio frequencies 862-890 MHz and/or 902-928 MHz may be used. For example, the radio frequencies 862-890 MHz and/or 902-928 MHz may provide significant benefits in light of available spectrums, allowed power levels, and available off-the-shelf radios and circuitry. For example, the radio frequencies 862-890 MHz and/or 902-928 MHz may be available for use by irrigation systems, operate at power levels that can provide for long range communications, and can utilize readily available off-the-shelf parts and communications standards. In one embodiment, the radio frequencies 862-890 MHz and/or 902-928 MHz may provide a communication range of one or more miles. Additionally, the range of the wireless signal may be expanded with the use of repeaters or repeater functionality.

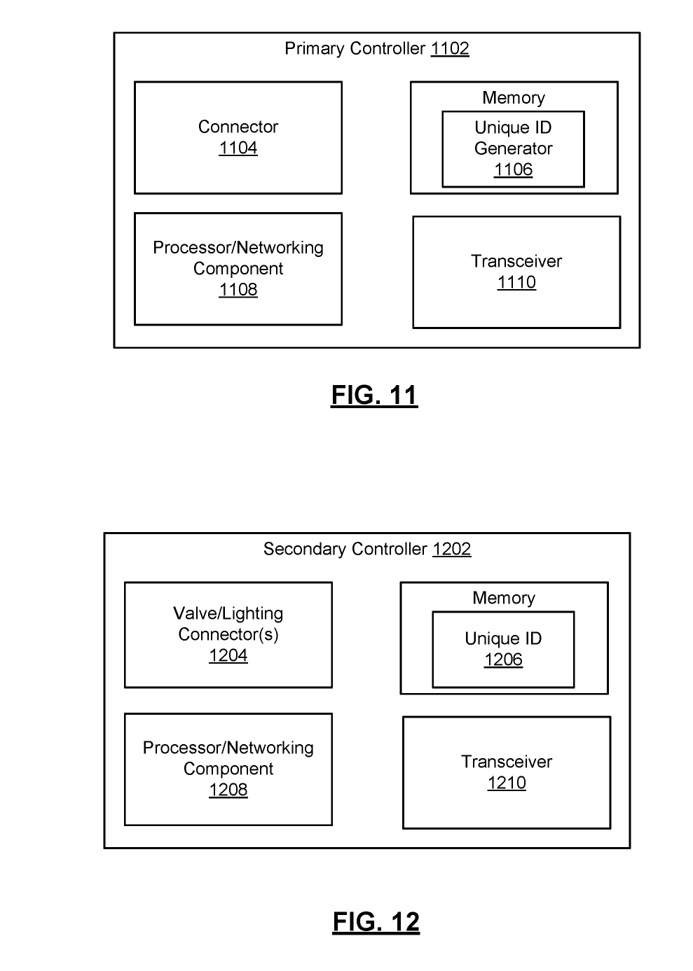

Illustrated in FIG. 11 is a schematic diagram of hardware used in one embodiment of a primary controller 1102. As illustrated, a primary controller 1102 may include a connector 1104 for connecting the primary controller control unit, expansion module, and/or an irrigation adapter, such as the control unit 412, expansion module 415, or irrigation adapter 413 of FIGS. 4 and 5. In one embodiment, the primary controller may include all of the control unit 412, expansion module 415, or irrigation adapter 413 of FIGS. 4 and 5. The primary controller 1102 may include memory storing instructions comprising a unique identifier (ID) generator 1106 for generating a unique identifier for each secondary controller, sensor, or the like upon pairing. As disclosed above, secondary controllers may be automatically detected as they are added to an irrigation system. The primary controller 1102 may further include a transceiver 1110 for facilitating the wireless communication between components. The transceiver 1110 may include an antenna and circuitry for long range communication, such as for sending and receive signals using a frequency in one of the ranges disclosed herein. Additionally, a processor and networking components 1108 may be included for executing instructions and network communication protocols.

Illustrated in FIG. 12 is a schematic diagram of hardware used in a secondary controller 1202, according to one embodiment. As illustrated, a secondary controller 1202 may include one or more connectors 1204 for connecting the secondary unit to an irrigation adaptor, lighting adapter, pool or hot tub adapter, or directly to irrigation components, lights, or the like. The secondary controller 1202 may include memory for storing a unique identifier 1206 that has been assigned by a primary controller, such as 1102 in FIG. 11. As disclosed above, secondary controllers may be automatically detected as they are powered on within a wireless range of a primary controller. In one embodiment, if the secondary controller 1202 is powered on and is not paired to a primary controller, the secondary controller 1202 may transmit a discovery message or beacon to indicate that it is available for pairing. The discovery message or beacon may include an identifier to indicate that it is configured to pairing to a primary controller, an irrigation network, an automated control network, or other network identifier or identifier of network type. The embodiment may further include a transceiver 1210 for facilitating the wireless communication between the secondary controller 1202 and a primary controller, a sensor, or the like. Additionally, processor and networking components 1208 may be included for executing instructions and network communication protocols.

One or more secondary controllers 1202 may be included or be part of various types of components, including an irrigation adapter for controlling irrigation valves or receive information from irrigation sensors (and forwarding sensor information to a primary controller, if needed), a lighting adapter for controlling indoor or outdoor lighting, and/or a pool adapter for controlling a pool or hot tub. For example, the secondary controller 1202 may control valves according to irrigation instructions, lighting according to lighting instructions, or pool pumps, lights, heating, or the like according to pool instructions. With the addition of one or more secondary controllers 1202 significant functionality as well as large networks and a high level control over residential, commercial, or other facilities or landscapes can be achieved.

According to one embodiment, controls of irrigation, lighting, or the like can be performed according to location specific temperature, sunset, weather, or other information. For example, cloud information about weather or sunsets for a particular zip code, sub-zip code, street, neighborhood, or the like can be obtained and used to calculate specific irrigation, lighting, or other instructions specific to zones, primary controllers, secondary controllers, or the like. With this fine grained data, extremely precise and efficient water and power savings instructions can be determined for precise locations of controllers or corresponding zones. In one embodiment, a cloud service may identify a closest weather station to the actual station of a controller to determine how to instruct the controller to water, illuminate, or perform other control for that specific location.

In an implementation, a secondary controller and/or a primary controller may store a lookup table in memory to identify wireless and wired components which may be connected. The normal standard of operation may include current usage values. In an implementation, a method may include suggesting a group of identified added expansion modules for selection by a user through the user interface. In an implementation, the method of generating the irrigation protocol includes communication with a supporting irrigation protocol server.

The expansion module of the disclosure may add additional irrigation zones and functionality of the controller. For example, the expansion module may add support for wireless communication. As another example, the expansion module may add sensor connectivity. It will likewise be understood that the added expansion module, when attached to the system, may self-identify. The sensing process may include receiving self-identifying information from the newly installed component or components, such as one or more expansion modules, or may be derived by sensing various electrical characteristics of the system such as current draw, resistance, inductance, impedance, etc., as electrical current flows through the system. The expansion module may include terminals configured to interface electrically with the irrigation system.

The methods of the disclosure may further include suggesting a group of identified operable irrigation components, such as one or more expansion modules, that are responsible for the deviation to a user and outputting the group for selection by the user for setup.

A system for the detection of an expansion module in an irrigation system during operation may include an irrigation system comprising plumbing and an irrigation controller. The irrigation system may include one or more operable irrigation components that are in electronic communication with the irrigation controller. An irrigation server may be connected to the irrigation controller over a computer network. The irrigation controller may receive an operating protocol from the irrigation server over the computer network. The irrigation controller may be configured for use as a component of the computer network.

As discussed herein above, the irrigation controller may include a control unit and an irrigation adaptor. The adaptor is configured to actuate the operable irrigation components that operate according to instructions issued from the control unit. The system may further include a sensor that is in electronic communication with the irrigation controller and may also include a baseline configuration of the operable irrigation components. The baseline configuration may be stored in computer memory. The deviation within the irrigation system may be sensed by the sensor, such that a deviation relative to the baseline configuration of the irrigation system results in the system sending a notification to a user regarding the sensed deviation establishing that an expansion module has been added to the system. It will be appreciated that a measurable increase above or a decrease below the baseline configuration may result in the system sending a notification to a user regarding the sensed deviation establishing either an addition to or deletion of an expansion module from the system, whereas a slight or small fluctuation above or below the baseline configuration may not. The deviation from the baseline configuration may be sensed when the expansion module is attached to the system. It will be appreciated that the deviation may be generated by the expansion module.

In an implementation of the system, the operable irrigation components may include an identifier, such that the operable irrigation component responsible for the deviation from the baseline configuration is identifiable by the identifier. In an implementation of the system, a signal may be sent to the controller from the sensor when there is a deviation from the baseline configuration, such that the system may alert the user that there is an expansion module either added or removed from the system.

In an implementation of the system, a new irrigation protocol may be generated by the irrigation server to include the newly attached expansion module, which may include one or more zones or new operable components. The new irrigation protocol may be stored in memory of the controller. In an implementation, the new protocol may be generated by the irrigation server or the controller. When the new protocol is generated by the server, there may be electronic or network communication with the irrigation server and the controller in order to send the protocol from the irrigation server to the controller.

In an implementation of the system, the baseline configuration may be a set of standard operating values of a baseline configuration of previously attached operable components. In an implementation of the system, the system may further include a lookup table that is retrieved from memory. The lookup table may identify a normal standard of operation of attached operable components. In an implementation of the system, the normal standard of operation includes standard operating values from a plurality of iterations of operating the irrigation system. In an implementation of the system, the normal standard of operation includes standard operating values corresponding to a plurality of iterations of operation of individual operable components. In an implementation of the system, a group of identified operable components responsible for the deviation may be suggested and output to a user for selection by the user.

It will be appreciated that a system of providing optimal irrigation in an irrigation system having a controller configured to be connected to an irrigation server over a computer network may include a computer network that itself may include an irrigation server and a protocol generator. The system may further include a controller. It will be appreciated that the controller may be in electronic communication with the plumbing of the irrigation system. The controller may also be in communication with the irrigation server over the computer network. Thus, when a communication connection between the controller and the server is established information and data may be exchanged between the server and the controller. For example, the server may formulate, generate and otherwise develop an irrigation protocol and/or a historical operational backup protocol and may send one or more of those protocols to the controller.

The controller, in return, may generate a transcript or other data relating to an iteration of the irrigation or watering event that may have just occurred. The transcript or other operational data may be sent from the controller to the irrigation server and the cloud or network service.

Additionally, in an implementation data may be stored and written, such as the irrigation protocol, into computer memory of the controller and/or server. The irrigation server may receive data reported back from the controller relating to an iteration of the irrigation protocol that has been executed. The protocol generator may use the reported back data to generate a historical backup protocol. The irrigation server may send the historical backup protocol to the controller wherein the historical backup protocol may be stored or written to the computer memory of the controller. The controller may retrieve the historical backup protocol from memory and may then execute the historical protocol if or when a connection between the irrigation server and the controller is not established.

In an implementation, the controller records irrigation iteration data into computer memory after the irrigation protocol has been executed by the controller. In an implementation, the controller records irrigation iteration data into computer memory until communication between the irrigation server and controller is reestablished. In an implementation, the controller may record irrigation iteration data for a plurality of iterations into computer memory after a plurality of irrigation protocols have been executed by the controller. In an implementation, the controller may record irrigation iteration data into computer memory until communication between the irrigation server and controller is reestablished.

In an implementation, the irrigation server may initiate and receive one or more notifications that may be output from the controller regarding the connection that was not established. In an implementation, the notification may be a visual output from the controller that operates as a visual cue to a user. In an implementation, the notification may be an audible signal output from the controller that operates as an audio cue to a user.

The system and method may generate a first start time that may act as a calendar item to send a follow-up query or notification to the user, for example a week later, to determine whether the user is pleased or otherwise satisfied with the health of the landscape, and if so, the system may reduce the amount of water a second time. The system and method may generate a calendar item to send a follow-up query or notification to the user, for example a week later, to determine whether the user is pleased or otherwise satisfied with the health of the landscape. If the user is satisfied, then the system may maintain the current duration for that zone.

The weather information may include current weather information and may be for a specific location that corresponds with the location of the controller of the plumbing system. The weather information may include data relating to current humidity, current temperature, current solar radiation, and/or current wind speed. The weather information may also provide additional data without departing from the scope of the disclosure.

In an implementation, the irrigation server may aggregate weather data from a single source or from a plurality of sources. In an implementation, the system and method may include a user web account, wherein the user web account is paired with the controller. In an implementation, the system may further include a notice generator that generates notifications for a user regarding events within the system, wherein the irrigation server transmits the notifications to the user prompting the user to enter data relating to the irrigation system and/or one or more irrigation zones of the irrigation system. In an implementation, the irrigation server may electronically communicate with the user through the web account located on a database and displayed using a general purpose computer, through a mobile device, and/or through the controller to send the notifications to the user.

The cloud or network service may perform many of the calculations and generate the irrigation protocols and other instructions that may be sent directly to the controller. Thus, it is the cloud or network service that provides the processing via one or more servers of the data obtained from one or more various aggregated weather sources or databases. In an implementation, the irrigation server may perform various computer implemented steps to utilize the current weather data that is provided at a regular predetermined interval, such as at one hour intervals, and generate the irrigation protocols that may be sent to the controller for actuation of the irrigation or plumbing system.

The irrigation server may electronically communicate with the controller. The irrigation server may also send one or more irrigation protocols to the controller over the computer network where the irrigation protocol is written into computer memory of the controller for execution by the controller. In an implementation, the system and method may utilize a clock that may be configured for providing time stamp data to events within the system. The one or more irrigation protocols may include time stamp data. Once the controller has received the one or more irrigation protocols, the controller executes the irrigation protocols to thereby actuate the irrigation or plumbing system.

In an implementation, the system and method the irrigation server may determine a slope of the ground, current temperature, and/or the geographical region type if there is no solar radiation data provided to the protocol generator. In an implementation, the irrigation server determines the slope of the ground, temperature, and/or the geographical region type prior to the protocol generator determining the amount of water needed to replenish the root zone for the given irrigation zone.

In an implementation, the system and method may further include initiating a notification to a user's communication device regarding the connection that was not established. In an implementation, the user communication device may be a computing device connected over a network. In an implementation, the network may include cellular network functionality. In an implementation, the user communication device may be a mobile device or other communication device capable of receiving notifications from a network. In an implementation, the system and method may further include initiating and receiving a notification output from the controller regarding the connection that was not established. It will be appreciated that in an implementation, the notification may be a visual output from the controller. In an implementation, the notification may be an audible signal output from the controller. In an implementation, the system and method may further include rechecking for network connectivity between the irrigation server and the controller.

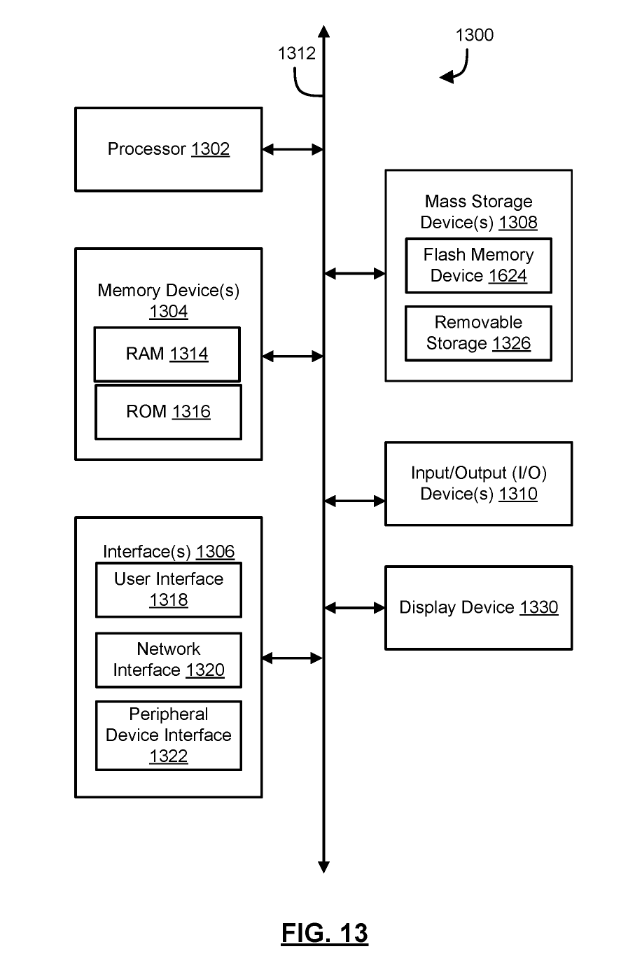

Referring now to FIG. 13, a block diagram of an example computing device 1300 such as a controller/control unit is illustrated. Computing device 1300, with appropriate hardware and/or software components, may be used to perform various procedures, such as those discussed herein. Computing device 1300 can function as a server, a client, or any other computing entity. Computing device 1300 can perform various monitoring functions as discussed herein, and can execute one or more application programs, such as the application programs described herein. Computing device 1300 can be any of a wide variety of computing devices, such as a desktop computer, a notebook computer, a server computer, a handheld computer, tablet computer and the like.

Computing device 1300 includes one or more processor(s) 1302, one or more memory device(s) 1304, one or more interface(s) 1306, one or more mass storage device(s) 1308, one or more Input/Output (I/O) device(s) 1310, and a display device 1330 all of which are coupled to a bus 1312. Processor(s) 1302 include one or more processors or controllers that execute instructions stored in memory device(s) 1304 and/or mass storage device(s) 1308. Processor(s) 1302 may also include various types of computer-readable media, such as cache memory.

Memory device(s) 1304 include various computer-readable media, such as volatile memory (e.g., random access memory (RAM) 1314) and/or nonvolatile memory (e.g., read-only memory (ROM) 1316). Memory device(s) 1304 may also include rewritable ROM, such as Flash memory.

Mass storage device(s) 1308 include various computer readable media, such as hard disk drives, magnetic tapes, magnetic disks, optical disks, solid-state memory (e.g., Flash memory), and so forth. As shown in FIG. 13, a particular mass storage device is a NAND flash memory device 1324. Various drives may also be included in mass storage device(s) 1308 to enable reading from and/or writing to the various computer readable media. Mass storage device(s) 1308 include removable media 1326 and/or non-removable media.

I/O device(s) 1310 include various devices that allow data and/or other information to be input to or retrieved from computing device 1300. Example I/O device(s) 1310 include cursor control devices, keyboards, keypads, microphones, monitors or other display devices, speakers, printers, network interface cards, modems, annular jog dials, and the like.

Display device 1330 includes any type of device capable of displaying information to one or more users of computing device 1300. Examples of display device 1330 include a monitor, display terminal, video projection device, and the like.

Interface(s) 1306 include various interfaces that allow computing device 1300 to interact with other systems, devices, or computing environments. Example interface(s) 1306 may include any number of different network interfaces 1320, such as interfaces to local area networks (LANs), wide area networks (WANs), wireless networks, and the Internet. Other interface(s) include user interface 1318 and peripheral device interface 1322. The interface(s) 1306 may also include one or more user interface elements 1318. The interface(s) 1306 may also include one or more peripheral interfaces such as interfaces for printers, pointing devices (mice, track pad, or any suitable user interface now known to those of ordinary skill in the field, or later discovered), keyboards, and the like.

Additionally, Bus 1312 may allow sensors 1311 to communicate with other computing components. Sensors may alternatively communicate through other components, such as I/O devices and various peripheral interfaces.

Bus 1312 allows processor(s) 1302, memory device(s) 1304, interface(s) 1306, mass storage device(s) 1308, and I/O device(s) 1310 to communicate with one another, as well as other devices or components coupled to bus 1312. Bus 1312 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1300, and are executed by processor(s) 1302. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### EXAMPLES

The following examples pertain to further embodiments.

Example 1 is an irrigation controller that includes a first radio, a control unit, and a second radio. The first radio is configured to wirelessly communicate with a wireless node to receive irrigation data for a location or an account corresponding to the irrigation controller. The control unit is configured to issue instructions to control flow of water through an irrigation system based on the irrigation data received via the first radio. The second radio is configured to communicate wirelessly with one or more remote irrigation adapters or sensors, wherein the second radio is configured for long range communication.

In Example 2, the second radio in Example 1 is configured to communicate wirelessly using a frequency within a range of about 902-928 MHz.

In Example 3, the second radio in any of Examples 1-2 is configured to communicate wirelessly using a frequency within a range of about 862-890 MHz.

In Example 4, the second radio in any of Examples 1-3 is configured to communicate wirelessly over a distance of about one mile.

In Example 5, the wireless node in any of Examples 1-4 includes an access point configured to communicate using an 802.11 communication standard.

In Example 6, the irrigation controller of any of Examples 1-5 further include one or more expansion modules and connectors configured to electrically connect the one or more expansion modules to the control unit, wherein at least one of the one or more expansion modules comprises the second radio.

In Example 7, the control unit in Example 6 is configured to be stacked on the one or more expansion modules.

In Example 8, the irrigation controller in Example 7 further includes an irrigation adapter, wherein the adapter is configured to actuate an operable irrigation component to control water flow through the irrigation system based on instructions from the control unit.

In Example 9, the control unit of any of Examples 6-8, includes one or more of: a housing substantially enclosing a circuit board; a control unit electronic connector providing electronic communication between the circuit board and the one or more expansion modules; and a user interface to receive input from a user.

In Example 10, the irrigation controller in any of Examples 1-9 is configured to: detect a presence of a new wireless irrigation adapter or sensor based on a wireless signal received from the new wireless irrigation adapter or sensor by the second radio; receive input from a user to add the new wireless irrigation adapter or sensor; and pair the new wireless irrigation adapter or sensor with the irrigation controller and communicate wirelessly with the new wireless irrigation adapter or sensor. For example, the irrigation controller may determine that an identifier in the signal indicates that the new wireless irrigation adapter or sensor is configured to pair or communicate with an irrigation controller. The irrigation controller may allow a human user to accept or deny pairing with the new wireless irrigation adapter or sensor.

In Example 11, the wireless irrigation adapter or sensor of any of Examples 1-10 includes one or more of a flow sensor and a moisture sensor.

In Example 12, the second radio in any of Examples 1-11 is configured to communicate wirelessly with one or more irrigation adapters, wherein the one or more irrigation adapters are configured to actuate an operable irrigation component to control water flow through the irrigation system based on instructions from the control unit received in wireless communications from the second radio.

In Example 13, the second radio in any of Examples 1-12 is further configured to communicate wirelessly with one or more of a lighting controller and a pool or hot tub controller.

Example 14 is a method for controlling an irrigation system. The method includes receiving irrigation data for a location or an account corresponding to an irrigation controller using a first radio, the first radio configured to communicate with a wireless access point. The method includes determining and issuing instructions, using a control unit, to control flow of water through an irrigation system based on the irrigation data received via the first radio. The method includes communicating wirelessly with one or more remote irrigation adapters or sensors using a second radio, wherein the second radio is configured for long range communication.

In Example 15, the second radio in Example 14 is configured to communicate wirelessly using one or more of: a frequency within a range of about 902-928 MHz; and a frequency within a range of about 862-890 MHz.

In Example 16, the first radio in any of Examples 14-15 is configured to communicate with a wireless node configured to communicate using an 802.11 communication standard. For example, the first radio may include a Wi-Fi radio.

In Example 17, communicating wirelessly in any of Examples 14-16 includes communicating using an expansion module configured to electrically connect with the control unit, wherein the expansion module includes the second radio

In Example 18, communicating wirelessly with one or more remote irrigation adapters or sensors in any of Examples 14-17 includes wirelessly transmitting instructions to an irrigation adapter, wherein the adapter is configured to actuate an operable irrigation component to control water flow through the irrigation system based on the instructions.

In Example 19, the method of any of Examples 14-18 further includes: detecting a presence of the one or more remote wireless irrigation adapters or sensors based on a wireless signal received from the wireless irrigation adapters or sensors by the second radio; receiving input from a user to approve addition of the one or more remote wireless irrigation adapters or sensors; and pairing the one or more remote wireless irrigation adapters or sensors with the irrigation controller and communicating wirelessly with the new wireless irrigation adapter or sensor.

In Example 20, an irrigation control system for use as a component of a computer network includes a first radio a control unit and at least one expansion module. The first radio is configured to wirelessly communicate with a wireless node to receive irrigation data for a location or an account corresponding to the irrigation control system. The control unit includes a housing substantially enclosing a circuit board, a control unit electronic connector providing electronic communication between the circuit board and the expansion module, an electronic display within the housing, and a user input device. The control unit is configured to be stacked onto the at least one expansion module, such that the control unit electronic connector of the control unit mates with a corresponding electronic connector of the expansion module. The expansion module includes a radio configured to communicate using a second radio configured to communicate wirelessly with one or more remote irrigation adapters or sensors, wherein the second radio is configured for communication using one or more of a frequency within a range of about 902-928 MHz and a frequency within a range of about 862-890 MHz.

In Example 21, the irrigation control system of Example 20 further includes an irrigation adapter. The irrigation adaptor is configured to actuate an operable irrigation component that determines the flow of water through an irrigation system according to instructions issued from the control unit.

In Example 22, the control unit and at least one expansion module in any of Examples 20-21 are configure to stack on the irrigation adapter.

In Example 23, the irrigation adapter of any of Examples 20-22 is configured to receive the instructions issued from the control unit via a wireless transmission from the second radio.

Example 24 is an apparatus including means to perform a method of any of Examples 14-19.

Example 25 is a machine readable storage including machine-readable instructions, when executed, to implement a method or realize an apparatus of any of Examples 1-24.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, include one or more physical or logical blocks of computer instructions, which may, for instance, be organized as an object, a procedure, or a function. Nevertheless, the executables of an identified component need not be physically located together, but may include disparate instructions stored in different locations that, when joined logically together, include the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. An irrigation controller comprising:
a first radio configured to wirelessly communicate with a wireless node to receive irrigation data for a location or an account corresponding to the irrigation controller;
a control unit, wherein the control unit is configured to issue instructions to control flow of water through an irrigation system based on the irrigation data received via the first radio; and
a second radio configured to communicate wirelessly with one or more remote irrigation adapters or sensors, wherein the second radio is configured for long range communication.

2. The irrigation controller of claim 1, wherein the second radio is configured to communicate wirelessly using a frequency within a range of about 902-928 MHz.

3. The irrigation controller of claim 1, wherein the second radio is configured to communicate wirelessly using a frequency within a range of about 862-890 MHz.

4. The irrigation controller of claim 1, wherein the second radio is configured to communicate wirelessly over a distance of about one mile.

5. The irrigation controller of claim 1, wherein the wireless node comprises an access point configured to communicate using an 802.11 communication standard.

6. The irrigation controller of claim 1, further comprising one or more expansion modules and connectors configured to electrically connect the one or more expansion modules to the control unit, wherein at least one of the one or more expansion modules comprises the second radio.

7. The irrigation controller of claim 4, wherein the control unit is configured to be stacked on the one or more expansion modules.

8. The irrigation controller of claim 5, further comprising an irrigation adapter, wherein the adapter is configured to actuate an operable irrigation component to control water flow through the irrigation system based on instructions from the control unit.

9. The irrigation controller of claim 4, wherein the control unit comprises one or more of:
a housing substantially enclosing a circuit board;
a control unit electronic connector providing electronic communication between the circuit board and the one or more expansion modules; and
a user interface to receive input from a user.

10. The irrigation controller of claim 1, wherein the irrigation controller is configured to:
detect a presence of a new wireless irrigation adapter or sensor based on a wireless signal received from the new wireless irrigation adapter or sensor by the second radio;
receive input from a user to add the new wireless irrigation adapter or sensor; and
pair the new wireless irrigation adapter or sensor with the irrigation controller and communicate wirelessly with the new wireless irrigation adapter or sensor.

11. The irrigation controller of claim 1, wherein the wireless irrigation adapter or sensor comprises one or more of a flow sensor and a moisture sensor.

12. The irrigation controller of claim 1, wherein the second radio is configured to communicate wirelessly with one or more irrigation adapters, wherein the one or more irrigation adapters are configured to actuate an operable irrigation component to control water flow through the irrigation system based on instructions from the control unit received in wireless communications from the second radio.

13. The irrigation controller of claim 1, wherein the second radio is further configured to communicate wirelessly with one or more of a lighting controllers and a pool or hot tub controller.

14. A method for controlling an irrigation system, the method comprising:
receiving irrigation data for a location or an account corresponding to an irrigation controller using a first radio, the first radio configured to communicate with a wireless access point;
determine and issue instructions, using a control unit, to control flow of water through an irrigation system based on the irrigation data received via the first radio; and
communicating wirelessly with one or more remote irrigation adapters or sensors using a second radio, wherein the second radio is configured for long range communication.

15. The method of claim 14, wherein the second radio is configured to communicate wirelessly using one or more of:
a frequency within a range of about 902-928 MHz; and
a frequency within a range of about 862-890 MHz.

16. The method of claim 1, wherein the first radio is configured to communicate with a wireless node configured to communicate using an 802.11 communication standard.

17. The method of claim 1, wherein communicating wirelessly comprises communicating using an expansion module configured to electrically connect with the control unit, wherein the expansion module comprises the second radio

18. The method of claim 1, wherein communicating wirelessly with one or more remote irrigation adapters or sensors comprises wirelessly transmitting instructions to an irrigation adapter, wherein the adapter is configured to actuate an operable irrigation component to control water flow through the irrigation system based on the instructions.

19. The method of claim 1, further comprising:
detecting a presence of the one or more remote wireless irrigation adapters or sensors based on a wireless signal received from the wireless irrigation adapters or sensors by the second radio;
receiving input from a user to approve addition of the one or more remote wireless irrigation adapters or sensors; and
pairing the one or more remote wireless irrigation adapters or sensors with the irrigation controller and communicating wirelessly with the new wireless irrigation adapter or sensor.

20. An irrigation control system for use as a component of a computer network comprising:
a first radio configured to wirelessly communicate with a wireless node to receive irrigation data for a location or an account corresponding to the irrigation control system;
a control unit; and
at least one expansion module;
wherein the control unit comprises:
a housing substantially enclosing a circuit board;
a control unit electronic connector providing electronic communication between the circuit board and the expansion module;
an electronic display within the housing;
a user input device;
wherein the control unit is configured to be stacked onto the at least one expansion module, such that the control unit electronic connector of the control unit mates with a corresponding electronic connector of the expansion module; and
wherein the expansion module comprises a second radio configured to communicate wirelessly with one or more remote irrigation adapters or sensors, wherein the second radio is configured for communication using one or more of a frequency within a range of about 902-928 MHz and a frequency within a range of about 862-890 MHz.

21. The irrigation control system of claim 20, further comprising an irrigation adapter, wherein the irrigation adaptor is configured to actuate an operable irrigation component that determines the flow of water through an irrigation system according to instructions issued from the control unit.

22. The irrigation control system of claim 21, wherein the control unit and at least one expansion module are configure to stack on the irrigation adapter.

23. The irrigation control system of claim 21, wherein the irrigation adapter is configured to receive the instructions issued from the control unit via a wireless transmission from the second radio.
